(19) United States
(12) Patent Application Publication
(10) Pub. No.: US 2021/0337891 A1
(43) Pub. Date: Nov. 4, 2021

(54) MASK AND METHOD OF MANUFACTURING THE SAME

(71) Applicant: Shalin Raj Shah, Princeton, NJ (US)

(72) Inventors: Shalin Raj Shah, Princeton, NJ (US); Annabelle Claire Wiedorn, Yardley, PA (US); Stephany Venuto, Millstone Twp, NJ (US)

(21) Appl. No.: 16/865,359

(22) Filed: May 3, 2020

(51) Int. Cl. A41D 13/11

(52) U.S. Cl. CPC A41D 13/11

(57) ABSTRACT

The present invention provides a mask and a method of manufacturing the same. The mask is manufactured by additive manufacturing process with elements increasing tolerance of the mask. The mask includes a base structure with a nasal chamber and a gas exchange filter configured for providing adequate protection to a user through multiple layers of anti-microbial filtration layers including filtration barriers of fiber material.

### BACKGROUND

### Technical Field

The present invention generally relates to masks. More particularly, the invention relates to masks and method of manufacturing the same.

### Description of the Prior Art

Protective devices such as Masks are extremely useful for safeguarding users working at variety of different places including industrial to medical facilities. Masks enhances worker safety at an industrial site and also ensure protection again exposure to air pollutants for a medical healthcare worker. Even for a common citizen, the masks are extremely useful for filtering dust and other particles.

The Masks depending on the environment of their use may require different level of protection for a user. Depending on the extremity of the conditions, the masks are manufactured with multiple level of safety provisions which in turn may lead to other issues such as difficulty in wearing the mask due to uncomfortable fit, difficulty in breathing in case the masks are to tight or have high level of filtration, weight of the mask in case of multiple layers of filtration etc. Moreover, it is extremely difficult to balance all requirements and ensure adequate safety.

The face contours of every user are different which also creates a challenge to develop a standard size mask with efficient filtration properties and adequate seal when worn by the user as improper seal may permit particulates to pass through different regions. Also, most of the masks available are not reusable and are single use masks which makes it a challenge for replacing them easily. Moreover, in case there is shortage of masks during time of a pandemic, it is extremely difficult for common public to find multiple disposable masks. Even with some reusable masks, the filters that are reused may lead to safety issues as the effectiveness of filtration may reduce with every use thereby making it a big challenge.

In view of the above, there exists a continuing need to provide protective devices that overcome the shortcoming associated with the prior arts.

### SUMMARY OF THE INVENTION

Accordingly, the present invention provides a mask. The mask includes a base structure having a nasal chamber and an integrated gas exchange filter. The mask includes a first filtration barrier placed between a posterior surface of a grill and an anterior surface of the gas exchange filter; and a second filtration barrier placed between a posterior surface of the gas exchange filter and a vent wherein the vent is configured to secure the second filtration barrier on the gas exchange filter. The orientation of the first filtration barrier and second filtration barrier is such that areas of adequate filtration on the first and the second barrier are aligned thereby ensuring increased filtration.

In an embodiment, the present invention provides a method of manufacturing a mask. The method includes analyzing by a computing device, a user's face contours for identifying target regions, determining configuration of a nasal chamber and a gas exchange filter based on the target regions to manufacture a mask base structure; and issuing a printing command to a 3D printer to print manufacture the base structure with the nasal chamber and the gas exchange filter such that an anterior surface of the gas exchange filter includes a plurality of tabs configured for securing a grill and increasing tolerance level of the mask manufactured by 3D printing process wherein a posterior surface of the gas exchange filter includes a plurality of cavities/dents to secure a plurality of protrusions of an anti-microbial vent, wherein a plurality of layers of materials is applied to form the base structure of the mask with a flat nose tip at exterior of the nasal chamber thereby maintaining 3D printing consistency.

In an embodiment, the method of manufacturing a mask includes injection molding a nasal chamber and a gas exchange filter onto a mask base structure; providing a removable grill configured to accommodate a first filter barrier and fixing to anterior of the gas exchange filter; forming a detachable vent configured to secure a second filter barrier to posterior of the gas exchange filter, wherein orientation of the first filtration barrier and second filtration barrier is such that areas of adequate filtration on the first and the second barrier are aligned thereby ensuring increased filtration.

In an embodiment, the present invention provides a system for manufacturing a mask. The system includes a computing means configured for analyzing face structure of a user to identify target regions wherein the computing means analyzes nasal structure and mouth structure of the user based on the target region for determining configuration of a base structure of a mask to be manufactured and a 3D printer configured for receiving a printing command to print manufacture the base structure with the nasal chamber and the gas exchange filter such that an anterior surface of the gas exchange filter includes a plurality of tabs configured for securing a grill and increasing tolerance level of the mask, wherein a posterior surface of the gas exchange filter includes a plurality of cavities/dents to secure a plurality of protrusions of an anti-microbial vent; wherein a plurality of layers of materials is applied to form the base structure of the mask with a flat nose tip at exterior of the nasal chamber thereby maintaining 3D printing consistency.

In an advantageous aspect the mask of the present invention is reusable mask. Moreover, the components of the mask such as the grill, the first filtration layer, the second filtration layer and the vent are removable thereby easily replaceable at low cost. Also, the base structure with nasal chamber and gas exchange filter provides efficient filtration due to the configuration of the components having multiple barriers. Further, the use of additive manufacturing process for printing the mask even in a personalized environment with a 3D printer makes it extremely useful and economical for any type of user whether a health care professional or common public at large.

In another advantageous aspect, the mask including all its components are printed from germicidal PIA filament. The printing process is accomplished with no additional supports permitting very little post-printing processing. Additionally, the mask has greater reuse capabilities, disposable options, and the mask affords the user a continued protection including in times of crisis and short supply. Furthermore, the masks' structural integrity makes it resistant to fractures during accidental and unintentional drops of the device.

### BRIEF DESCRIPTION OF THE DRAWINGS

The disclosure will be better understood and when consideration is given to the drawings and the detailed description which follows. Such description makes reference to the annexed drawings wherein:

FIG. 1 is an exploded view of a mask with multi-layer filtration components in accordance with an embodiment of the invention.

FIG. 1A is a perspective view the mask in accordance with an embodiment of the invention.

FIG. 1B is perspective view of a grill and a gas exchange filter of the mask with a first and a second filtration barrier in accordance with an embodiment of the invention.

FIG. 1C is a perspective view of grill posterior and base structure anterior of the mask in accordance with an embodiment of the invention.

FIG. 1D is a perspective view of a vent and base structure posterior with gas exchange filter in accordance with an embodiment of the invention.

FIG. 1E is a perspective view of the base structure posterior in accordance with an embodiment of the invention.

FIG. 2 is a flowchart depicting a method of manufacturing a mask in accordance Pit a embodiment of the invention.

FIG. 3 is a system for manufacturing a mask in accordance with an embodiment of the invention.

### DETAILED DESCRIPTION

Described herein are nonlimiting example embodiments of the present invention, which includes mask and a method of manufacturing the same.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “filtration barrier,” “filters,” or “fiber material,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to a mask and a method of manufacturing the same.

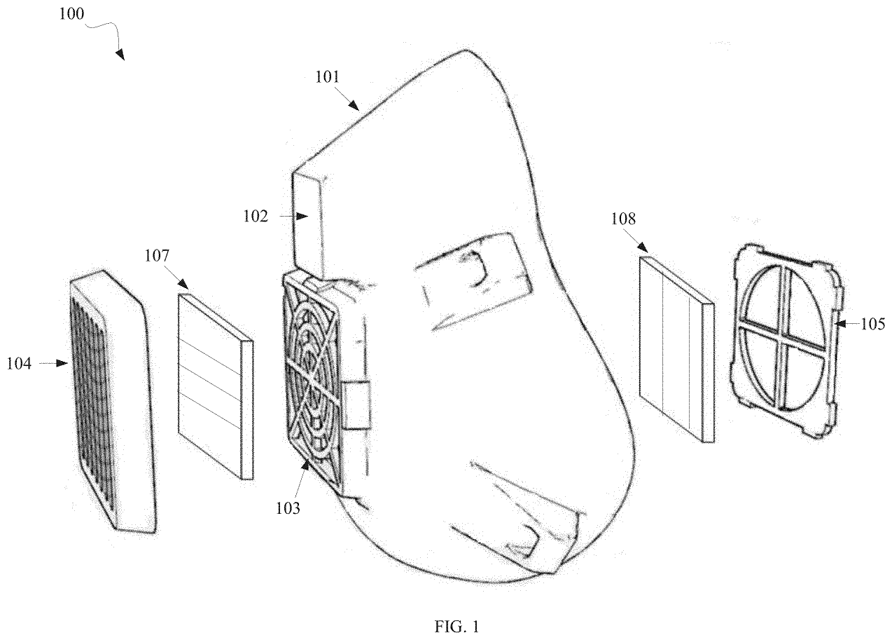

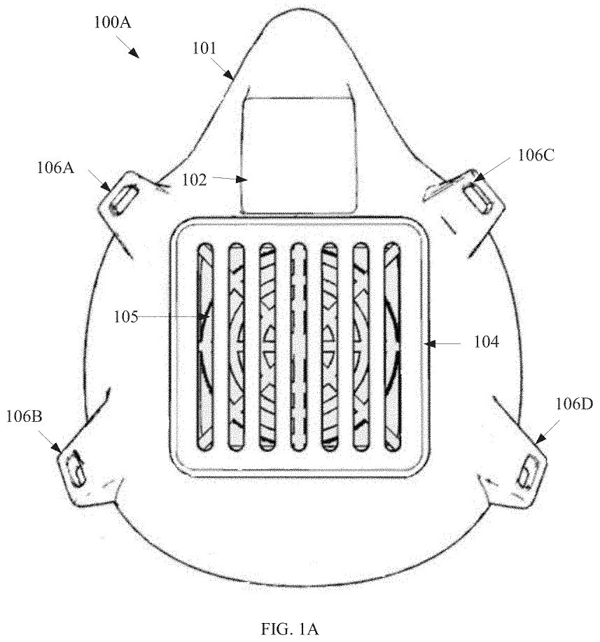

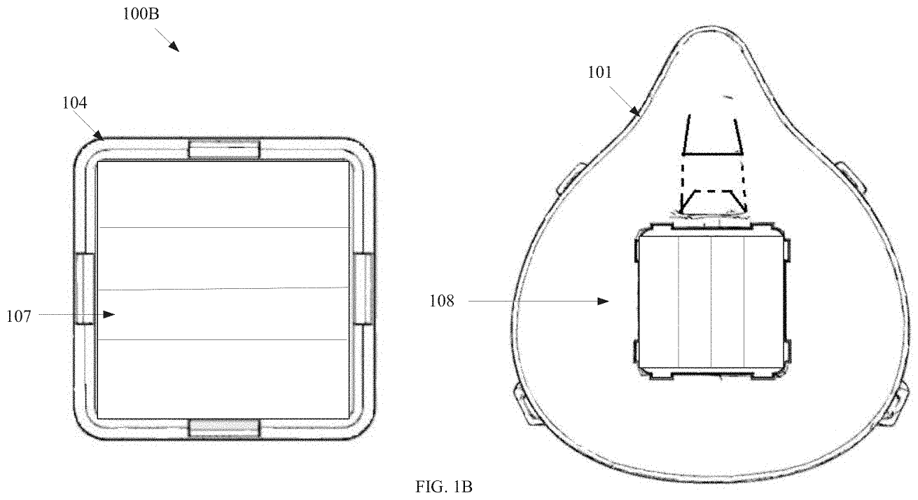

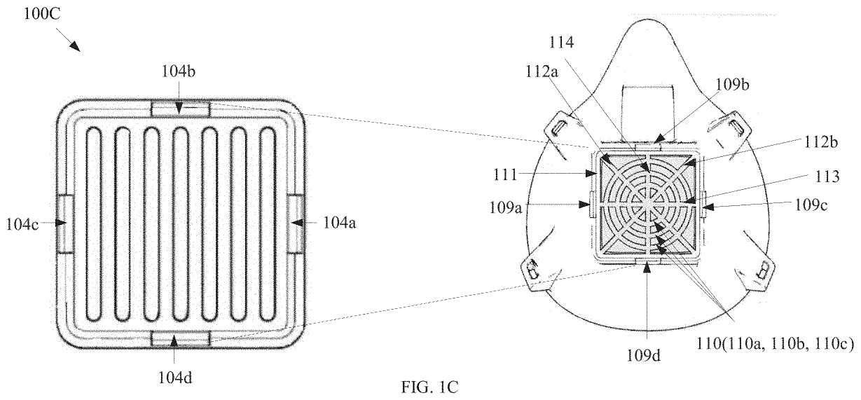

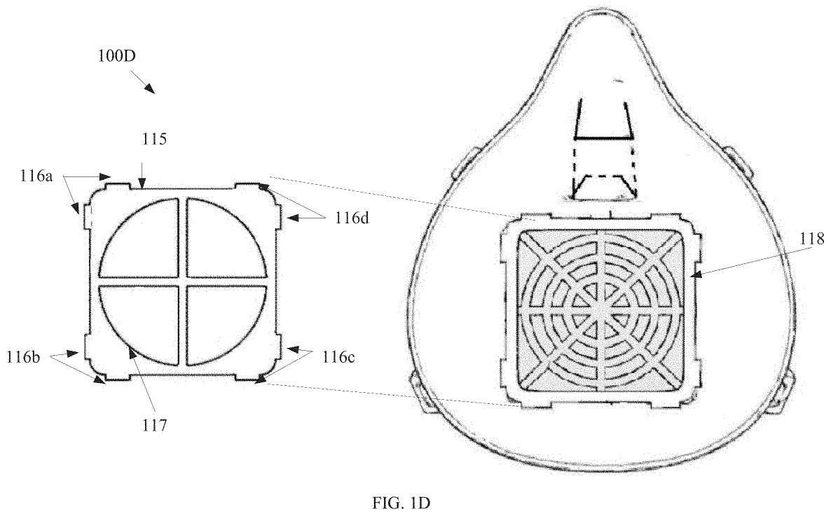

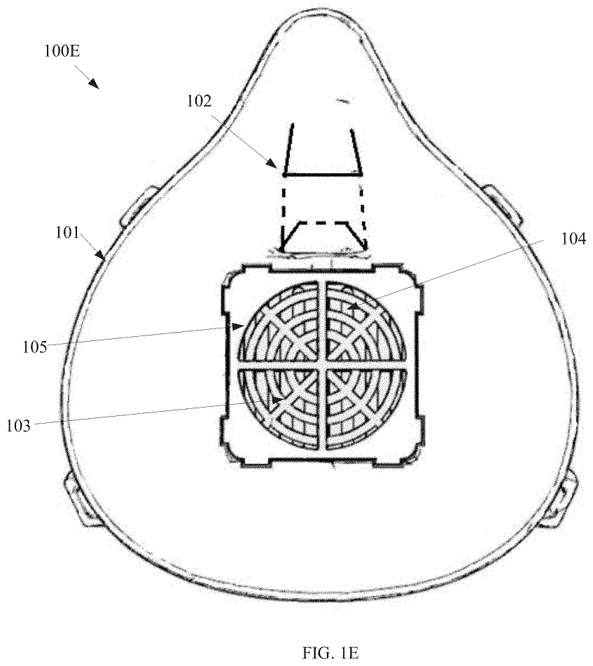

Referring to FIGS. 1 and 1A, a perspective view of a mask 100 and 100a is provided in accordance with an embodiment of the present invention. The mask (100, 100a) includes a body structure 101 including a nasal chamber 102 and an integrated gas exchange filter 103. The mask 100 also includes removable grill 104 and a removable vent 105. The mask 100 includes a plurality of strap holders 106 (106a, 106b, 106c, 106d) configured to retain and fit the mask properly on the face of a user.

In an exemplary embodiment, the mask 100 includes a first filtration barrier 107 and a second filtration barrier 108 as shown in FIG. 1 and FIG. 1B. The first filtration barrier 107 is placed between a posterior surface of the grill 104 and an anterior surface of the gas exchange filter 103. The second filtration barrier 108 is placed between a posterior surface of the gas exchange filter 103 and the vent 105. The vent 105 is configured to secure the second filtration barrier 108 on the gas exchange filter 103.

In a preferred embodiment, the first and second filtration barrier are made of a flexible material and the base structure, the vent, and grill are formed from a material that is more rigid.

In an exemplary embodiment, the first filtration barrier 107 and second filtration barrier 108 are removable filters of fiber material such as polypropylene. However, the barriers may be of any other filtration material with properties of enhanced filtration against particulates like air pollutants, bacteria and virus.

In an embodiment, the orientation of the first filtration barrier, the second filtration barrier and the bars of the grills are vertical or horizontal or diagonal, In an example embodiment, as shown in FIGS. 1, 1A and 1B, the grill 104 includes vertical bars as barriers, the first filtration barrier 107 is secured in a horizontal orientation at posterior of the grill 104, the second filtration barrier 108 is secured in a vertical orientation on the gas exchange filter 103.

In an exemplary embodiment, the orientation of the first filtration barrier and the second filtration barrier is identified based on a face structure of the user. For example, if the mouth of a user is long, the grill can include horizontal bars as barriers, the first filtration barrier can be oriented vertical, and second barrier is oriented horizontal. If the mouth of the user is wide, the grill includes vertical bars as barriers, the first filtration barrier as horizontal and second barrier as vertical. Such dynamic configuration of filtration barriers enables enhanced safety for all users.

In another exemplary embodiment, the masks with standard sized components (base structure, grill, filtration barrier, vents) can also be mass manufactured through molding in addition to the customized 3D printing manufacturing process as the orientation of these components can be altered depending on the face contours of a user. Since, these are removable and replaceable components the costs are extremely low, and the mask can be still be customized regardless of the manufacturing process.

In an embodiment, the base structure 101 of the mask 100 is manufactured with minimum amount of PLA. Moreover, even with reduced PLA with 3D printer manufacturing, the mask manufactured with anti-germicide properties still retains the needed durability and structural integrity while reducing the weight of the mask significantly. Common hazards of prolonged use of mask is bruising, abrasions, and other dermal trauma. The mask is configured to retain protective mechanism while also ensuring the comfort for the user.

In an exemplary embodiment the nasal chamber 102 is enlarged in the anterior and inferior lateral areas to provide greater comfort. Moreover, an inside surface of the nasal chamber 102 is configured as a channel with side walls to secure cartilages of nose of a user such that air exhalation moves downwards reducing upward air flow that could consequently cause fogging of protective eyewear. In another embodiment, the anterior surface of the nasal chamber 102 at a nose tip area is flat that also enhances 3D printing consistency and contributes to not requiring any supports when printing.

In an exemplary embodiment, the mask (100, 100A) has high adaptability to many different facial forms, thereby enhancing form-fitting capabilities.

In an embodiment, the mask is manufactured using 3D printer as part of additive manufacturing process. The additive manufacturing process also allows customization of the mask as per the face structure of a user.

In another embodiment, the mask 100 is manufactured using injection molding or hybrid manufacturing process.

Referring to FIG. 1C, a perspective view 100C of the gas exchange filter 103 and the grill 104 is shown in accordance with an embodiment of the present invention. The integrated gas exchange filter 103 is also directly printed into the base layer 101. The anterior surface of the gas exchange filter 103 includes a plurality of protrusions/tabs 109 (109A, 109B, 109C, 109D) configured to engage with the posterior surface of the grill 104 through a plurality of cavities/dent (104A, 104B, 104C, 104D) thereby ensuring enhanced retention of the grill 104. The mask 100 has enhanced articulation and retention mechanism of the external antimicrobial grill 104 due to these tabs 109. The tabs 109 not only enhance engagement mechanism between the external, anti-microbial grill 104 and the integrated gas exchange filter 103 but also increases tolerance level of the mask manufactured by 3D printing process. These masks 100 can be properly reproduced at all levels and provide the intimacy required for the demand and casual wearer. The tabs 109 connected to borders and on the perimeter of the integrated gas exchange filter 103 enhances tolerance.

In an embodiment, the posterior of the grill includes adequate chamber depth to accommodate a wide array of removable and replaceable filters. Also, the recessed fittings including the cavities (104a, 104b, 104c, 104d) on the grill articulate with the base structure efficiently to provide improved sealing arrangement.

Referring to FIGS. 1B and 1C, the grill 104 as an external recessed chamber serves as a removable filtration reservoir for additional protection. In an example embodiment, a Level 2/3 surgical mask could be cut an inserted into the grill 104 as a removable filter. The filtration efficiency increases by placing the surgical mask horizontal and perpendicular to the external antimicrobial grill, which has vertical barriers. The configuration, type and orientation of the removable filters are arranged to ensure enhanced filtration for the mask. It shall be understood that the orientation of the filters depending on their structural configuration may be varied for adequate filtration within the scope of the present invention.

In an exemplary embodiment, the gas exchange filter 103 includes a plurality of rings HO (110A, 110B) inside a rectangular gas exchange filter frame 111 intersected by diagonal bars 112 (112A, 112B), vertical bar 113 and horizontal bar 114 for filtration. The complex framework of the gas exchange filter 103 allows for an effective anti-microbial barrier while also allowing for needed inhalation and exhalation for the user. The integrated gas exchange filter 103 ensures no exposure of particles to the user at any time even when changing out removable filters. While the preferred configuration of the gas exchange filter 103 are as shown in the FIG. 1-1A, it shall be understood to a person skilled in the art that the configuration of the gas exchange filter 103 including the barriers with rings, diagonal, vertical and horizontal bars may be altered without departing from the scope of the present invention.

In an embodiment, the vent 105 of the present invention includes a vent frame 115 with protrusions (116A, 1168, 1160, 116D) configured to secure on a plurality of cavities/dents of the interior surface of the gas exchange filter 103 as shown in posterior view (100D, 100E) of the mask in FIGS. 1D and 1E. The vent 105 includes a ring 117 configured to align with at least one of the plurality of rings 110 of the gas mask thereby ensuring secure fit of the second filtration barrier 108. The geometric and intricate cutout 118 of the vent 105 is directly incorporated into the mask base structure 101 to ensure a consistent and reliable fit of the internal, anti-microbial vent 105.

Referring to FIGS. 1B, 1D and 1E, the internal antimicrobial vent 105 and the gas exchange filter 103 as an internal recessed chamber both serve as additional layers of protection to the user while also enabling the user to have proper and effective gas exchange. The internal recessed chamber/gas exchange filter 103 also serves as a removable filtration reservoir for additional protection. In an example embodiment, a Level 2/3 surgical mask could be cut an inserted into the internal recessed chamber/gas exchange filter 103 at posterior. Unlike the horizontal orientation of the surgical mask in the external recessed chamber/grill 104 at posterior, the surgical mask cutout is placed vertical on the filter 103 at posterior. The filtration barriers/surgical masks (107, 108) are arranges such that areas of inadequate filtration in the surgical mask do not line up when the section of the mask is placed horizontally and then the subsequent layer is placed vertically. Further, surrounding both filtration barrier/surgical mask layers in perpendicular orientation are three germicidal layers.

In an exemplary embodiment, further barriers may be added to protect the user while also ensuring gas exchange can occur without excessive effort and labor.

In an advantageous aspect, the mask is manufactured by additive manufacturing process or injection molding and manufacturing or hybrid manufacturing process.

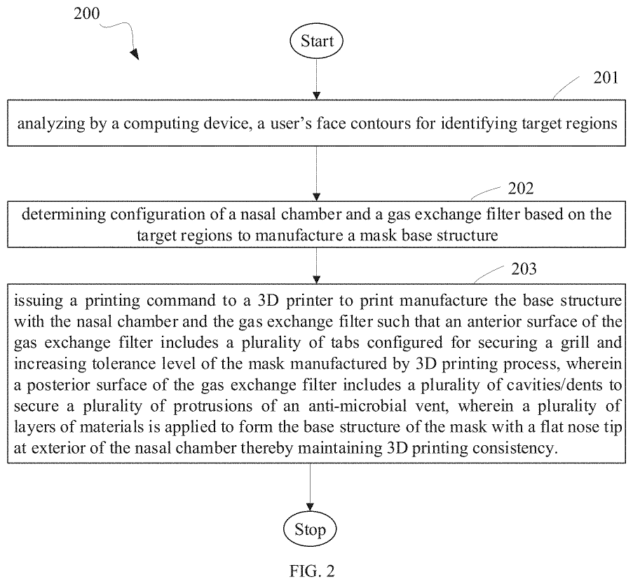

Referring to FIG. 2 a flowchart depicting a method of manufacturing a mask is provided. in accordance with an embodiment of the present invention. The method includes the steps of S201 analyzing by a computing device, a user's face contours for identifying target regions. In S202, determining configuration of a nasal chamber and a gas exchange filter based on the target regions to manufacture a mask base structure. In S203, issuing a printing command to a 3D printer to print manufacture the base structure with the nasal chamber and the gas exchange filter such that an anterior surface of the gas exchange filter includes a plurality of tabs configured for securing a grill and increasing tolerance level of the mask manufactured by 3D printing process, wherein a posterior surface of the gas exchange filter includes a plurality of cavities/dents to secure a plurality of protrusions of an anti-microbial vent, wherein a plurality of layers of materials is applied to form the base structure of the mask with a flat nose tip at exterior of the nasal chamber thereby maintaining 3D printing consistency.

In an embodiment, the target regions include multiple regions on the face of a user like nose including bridge of nose, chin, cheek etc. The target regions enable identification of structure of a mask desired to be manufactured as a customized mask for a user. Alternately, as part of mass production, the standard size of mask based on target regions is also manufactured by the method of the present invention. The standard sized mask also provides a reliable seal when worn properly.

The mask can be form-fitted by placing in hot water for 30-60 second ensuring a proper and intimate fit for the user.

In an advantageous aspect, the additive manufacturing process using the anti-germicidal properties of the PLA filament provide an enhanced layer of protection compared to a disposable mask like N95 respirator. Additionally, the mask of the present invention uses multiple chambers for added filtration. In an exemplary embodiment, the mask of the present invention including carefully crafted components grill, a first filtration barrier, a base structure with nasal chamber and gas exchange filter, a second filtration barrier and a Vent provide potentially a higher level of protection than any of the existing respirator while affording the user adequate breathability. Further, most disposable respirators have short usability due to breakdown post-fluid exposure and user moisture production. The mask of the present invention with PLA filament structure enables it to be more resistant to fluids and thereby increasing its reusability.

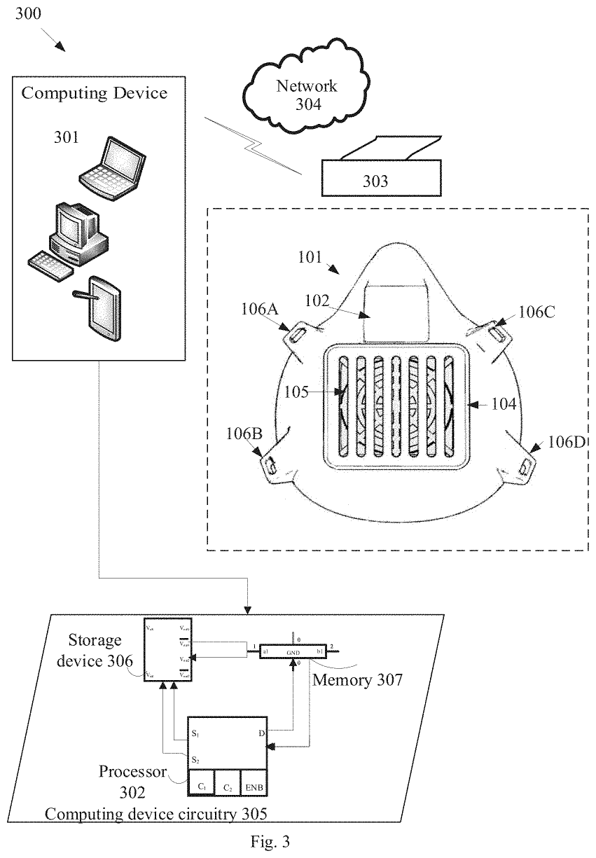

Referring to FIG. 3, a system 300 for manufacturing a mask is provided in accordance with an embodiment of the present invention. The system 300 includes a computing device 301 configured to process data related to face structure of a user. The system also includes a processor 302 configured for processing the data to determine a model of the mask to be manufactured. The computing device 301 of the system 300 analyzes face structure of a user to identify target regions wherein the computing means analyzes nasal structure and mouth structure of the user based on the target region for determining configuration of a base structure of a mask to be manufactured. The system 300 also includes a 3D printer 303 configured for receiving a printing command from the computing device 301 to print manufacture the base structure with the nasal chamber and the gas exchange filter such that an anterior surface of the gas exchange filter includes a plurality of tabs configured for securing a grill and increasing tolerance level of the mask. The system 300 enables manufacturing of the mask with a posterior surface of the gas exchange filter that includes a plurality of cavities/dents to secure a plurality of protrusions of an anti-microbial vent. Also, the mask is manufactured with a plurality of layers of materials applied to form the base structure of the mask with a flat nose tip at anterior of the nasal chamber thereby maintaining 3D printing consistency.

In an embodiment, the computing device 301 may enable wireless communication with the 3D printer 303 through a communication interface over a network 304, which may include signal processing circuitry. Also, the device may be any computing device capable of processing the face structure image of a user, for example, a computer or mobile device or other similar devices. Alternatively, the command to print the mask may be issued by another device or through the server. The computing means 301 includes internal circuitry 305 that includes processor 302, storage device 306 and memory 307 amongst others.

The processor 302 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user and convert them for submission to the processor. In addition, an external interface may be provided in communication with processor, so as to enable near area communication of device with other devices such as 3D printer. External interface may provide, for example, for wired communication in some implementations, or for wireless communication in other implementations, and multiple interfaces may also be used.

In an embodiment, the computing device 301 scans and analyzes face contours of the user to identify the target region and maps information about the target region with a mask model to determine required angles, orientations, positioning, distances and size parameters for manufacturing the mask.

In an exemplary embodiment, the mask is configured with an ergonomic base structure that can be heat-molded to become form-fitting to the user's face. The mask utilizes four, external attachments to provide both high and low anchorage for the user to ensure a continued secure fit. The mask is designed with an in-built cartridge filtration system that also permits two areas for replaceable filtration. These two filter locations are designed with airflow in mind to ensure proper gas exchange while also providing the necessary barrier protection against foreign elements including viruses and bacteria. The mask filtration system also is designed around the utilization of a reduced footprint in consumables thereby increasing its participation in environmentally friendly devices. For example, a standard Level 2 or Level 3 surgical mask can even be used almost four different times in the mask cartridge filtration system—meaning eight pieces can be retrieved from a single surgical mask. The mask chambers are also large enough to accommodate pieces of a Level 2/3 surgical mask as well as charcoal filters, pieces of HEPA filters, sections of a N99 surgical gown, parts of an N95 mask, or any filtration of the user's choice. The two, removable cartridge filtration components have a tight seal and intimacy with the base mask affording both protection and durability in the active and demanding healthcare space. These removable parts can easily be reprinted at a low cost and on demand within healthcare facilities capable of 3D printing. The external, anti-microbial grill and the internal, anti-microbial vent along with the integrated, gas exchange filter in the base layer and the multiple chambers for removable filtration account for five-layers of antigen barriers in the mask. The protection features, low requirement of accessible filter consumables, and sound structure of the mask makes it an economical yet efficient protective device that can be manufactured and used in shortest possible timeframe on a real time basis.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

What is claimed is:

1. A mask comprising:
a base structure including a nasal chamber and an integrated gas exchange filter;
a first filtration barrier placed between a posterior surface of a grill and an anterior surface of the gas exchange filter; and
a second filtration barrier placed between a posterior surface of the gas exchange filter and a vent wherein the vent is configured to secure the second filtration barrier on the gas exchange filter;
wherein orientation of the first filtration barrier and second filtration barrier is such that areas of adequate filtration on the first and the second barrier align thereby ensuring increased filtration.

2. The mask of claim 1 wherein the anterior surface of the gas exchange filter includes a plurality of protrusions/tabs configured to engage with the posterior surface of the grill through a plurality of cavities/dent thereby ensuring enhanced retention of the grill.

3. The mask of claim 1 wherein the orientation of the first filtration barrier is different from the orientation of the second filtration barrier and orientations of a plurality of bars of the grill.

4. The mask of claim 3 wherein the orientation of the first filtration barrier, the second filtration barrier and the bars of the grills are vertical or horizontal or diagonal.

5. The mask of claim 4 wherein the orientation of the first filtration barrier and the second filtration barrier is identified based on a face structure of the user.

6. The mask of claim 1 wherein an inside surface of the nasal chamber is configured as a channel with side walls to secure cartilages of nose of a user such that air exhalation moves downwards reducing upward air flow.

7. The mask of claim 6 wherein an anterior surface of the nasal chamber at a nose tip area is flat.

8. The mask of claim 4 wherein the first filtration barrier and second filtration barrier are removable filters of fiber material such as polypropylene.

9. The mask of claim 2 wherein the gas exchange filter includes a plurality of rings inside a rectangular gas exchange filter frame intersected by diagonal, vertical and horizontal bars for filtration.

10. The mask of claim 9 wherein the vent includes a vent frame with protrusions configured to secure on a plurality of cavities/dents of the interior surface of the gas exchange filter wherein the vent includes a ring configured to align with at least one of the plurality of rings of the gas mask thereby ensuring secure fit of the second filtration barrier.

11. The mask of claim 1 wherein the mask is manufactured by additive manufacturing process or injection molding and manufacturing or hybrid manufacturing process.

12. A method of manufacturing a mask, the method comprising:
analyzing by a computing device, a user's face contours for identifying target regions;
determining configuration of a nasal chamber and a gas exchange filter based on the target regions to manufacture a mask base structure; and
issuing a printing command to a 3D printer to print manufacture the base structure with the nasal chamber and the gas exchange filter such that an anterior surface of the gas exchange filter includes a plurality of tabs configured for securing a grill and increasing tolerance level of the mask manufactured by 3D printing process;
wherein a posterior surface of the gas exchange filter includes a plurality of cavities/dents to secure a plurality of protrusions of an anti-microbial vent;
wherein a plurality of layers of materials is applied to form the base structure of the mask with a flat nose tip at exterior of the nasal chamber thereby maintaining 3D printing consistency.

13. The method of claim 12 further comprises the step of manufacturing the grill by additive manufacturing process wherein the grill includes a plurality of vertical or horizontal or slanting bars acting as filters.

14. The method of claim 12 further comprises the step of manufacturing the anti-microbial vent by additive manufacturing process.

15. The method of claim 12 further comprises the step of placing a first filtration barrier between a posterior surface of a grill and an anterior surface of the gas exchange filter.

16. The method of claim 15 further comprises the step of placing a second filtration barrier between a posterior surface of the gas exchange filter and a vent wherein the vent is configured to secure the second filtration barrier on the gas exchange filter.

17. The method of claim 16 wherein orientation of the first filtration barrier and second filtration barrier is such that areas of adequate filtration on the first and the second barrier are aligned thereby ensuring increased filtration.

18. The method of claim 12 wherein the base structure, the grill and the vent are printed with germicidal PLA filament material.
